(19) United States
(12) Patent Application Publication
(10) Pub. No.: US 2009/0034247 A1
(43) Pub. Date: Feb. 5, 2009

(54) LIGHTING APPARATUS

(76) Inventor: John D. Boyer, Lebanon, OH (US)

Correspondence Address: MCDERMOTT WILL & EMERY LLP, 28 STATE STREET, BOSTON, MA, 02109-1775, US

(21) Appl. No.: 12/183,403

(22) Filed: Jul. 31, 2008

Related U.S. Application Data
(60) Provisional application No. 60/953,009, filed on Jul. 31, 2007.

(51) Int. Cl. F21V 15/01; F21S 4/00

(52) U.S. Cl. 362/225; 362/365

(57) ABSTRACT

A lighting apparatus having a housing having a planar base having one or more recesses, and one or more light source assemblies disposed within the recesses. In one embodiment the light source assemblies consist of a substrate configured in shape to register with the recess, and a plurality of light sources affixed to the substrate, and a means for securing the substrates within the recesses. A potting epoxy can be used to cover the lighting source assembly and fill the recess.

### FIELD OF THE DISCLOSURE

The present disclosure relates generally to luminaires and other light fixtures and, more particularly, to a lighting apparatus in the form of a luminaire supporting an assembly of light sources.

### BACKGROUND OF THE DISCLOSURE

As advances have been made in the quality and energy efficiency of light emitting diodes (LEDs), the production cost of LEDs has gone down, and LEDs are being commonly used in a wide variety of area lighting applications. Initial efforts to incorporate LEDs into lighting fixtures have involved retrofitting LEDs into conventional luminaires or onto or into the shape of conventional lighting lamps.

More recently, luminaires are being designed to account for the function and specifications of LEDs. LEDs are typically combined together in arrays onto printed circuit boards (PCBs) for ease of handling and modularity. Assembling the LEDs and the PCBs into a housing or luminaire can require precise positioning of the individual LEDs and/or the PCBs to achieve the desired array or required lighting effects from the plurality of LEDs and their associated optics or reflectors. Retrofitting LEDs into an existing luminaire or housing can raise issues related to positioning and securing the LEDs or PCBs into the housing or luminaire, to providing the correct and adequate power and controls for the LEDs, and to maintaining the appropriate appearance and aesthetics of the luminaire.

### SUMMARY OF THE DISCLOSURE

The present disclosure relates generally to a lighting apparatus comprising a housing including a planar base having at least one recess, at least one light source configured in shape corresponding to that of the at least one recess.

In one aspect, the disclosure therefore relates to a lighting apparatus comprising a housing having a substantially planar base, the base defining at least one recess of selected shape, each recess having a floor and defined in the shape by a peripheral wall joining the floor to the planar base; at least one light source assembly, each assembly including a plurality of light sources arranged to correspond in shape substantially to the shape of the recess and configured to register with the floor of the recess, the at least one light source assembly disposed within the recess; and a fastening mechanism that secures the at least one light source assembly within the recess.

The disclosure also relates to a lighting apparatus comprising a housing having a substantially planar base, the base including at least one recess of selected shape, each recess having a floor and defined in shape by a peripheral wall joining the floor to the planar base, and a peripheral wall attached to or integral with the planar base, having on the distal edge thereof an inwardly directed marginal flange that defines an opening in registry with the planar base; at least one light source assembly, each the assembly including a plurality of light sources arranged to correspond in shape substantially to the shape of the recess and configured to register with the floor of the recess, the at least one light source assembly disposed within the recess and secured within the recess; and an optional transparent or translucent panel sized to cover the opening and configured to be supported on the marginal flange.

The disclosure also relates to a lighting apparatus comprising: a housing having a substantially planar base, the base defining at least one recess of selected shape, each the recess having a floor and defined in shape by a peripheral wall joining the floor to the planar base, and a peripheral wall attached to or integral with the planar base having on the distal edge thereof an inwardly directed marginal flange that defines an opening in registry with the planar base; at least one light source assembly, each assembly including a plurality of light sources arranged to correspond in shape substantially to the shape of the recess and configured to register with the floor of the recess, the at least one light source assembly disposed within the recess and secured within the recess; and a cover plate disposed within the opening, the cover plate comprising a substantially planar bottom member and peripheral side walls attached to or integral with the planar bottom, the planar bottom member further defining a plurality of openings, each opening in registration with one of the plurality of light sources; and an optional transparent or translucent panel sized to cover the opening and configured to be supported on the marginal flange.

In another aspect of the disclosure, the recess and the associated substrate are substantially elongated, linear, and the housing has a plurality of elongated recesses, and a plurality of the light source assemblies disposed within the plurality of recesses, typically in juxtaposition with one another.

In one aspect of the housing and reflector of the disclosure, they are formed of aluminum, although other materials, including metals, plastics, composites, fiber glass may be used. In one aspect of the light sources of the invention, they comprise LEDs secured with a potting epoxy or other adhesive material that covers at least a portion of each LED assembly and fills at least a portion of each recess.

### BRIEF DESCRIPTION OF THE DRAWINGS

FIG. 1 shows a perspective view of one embodiment of a lighting apparatus that includes a housing, a cover plate and a lens.

FIG. 2 shows an exploded view of the lighting apparatus of FIG. 1.

FIG. 3 shows a sectional view of the lighting apparatus of FIG. 1 taken through line 3-3 thereof.

FIG. 4 shows a sectional view of the housing of the lighting apparatus of FIG. 1 taken through line 4-4 thereof.

FIG. 5 shows an alternative embodiment of the planar base of a housing structure of a lighting apparatus.

FIG. 6 shows an alternative structure for the recesses in the planar base of the housing structure of a lighting apparatus.

FIG. 7 shows another alternative structure for the recesses in the planar base of the housing structure of a lighting apparatus.

FIG. 8 shows a front side view of the housing shown in FIG. 1, wherein the back side view is the same.

FIG. 9 shows a right side view of the housing shown in FIG. 1, wherein the left side view is the same.

FIG. 10 shows a top plan view of the housing shown in FIG. 1.

FIG. 11 shows a bottom plan view of the housing shown in FIG. 1.

### DETAILED DESCRIPTION OF THE DISCLOSURE

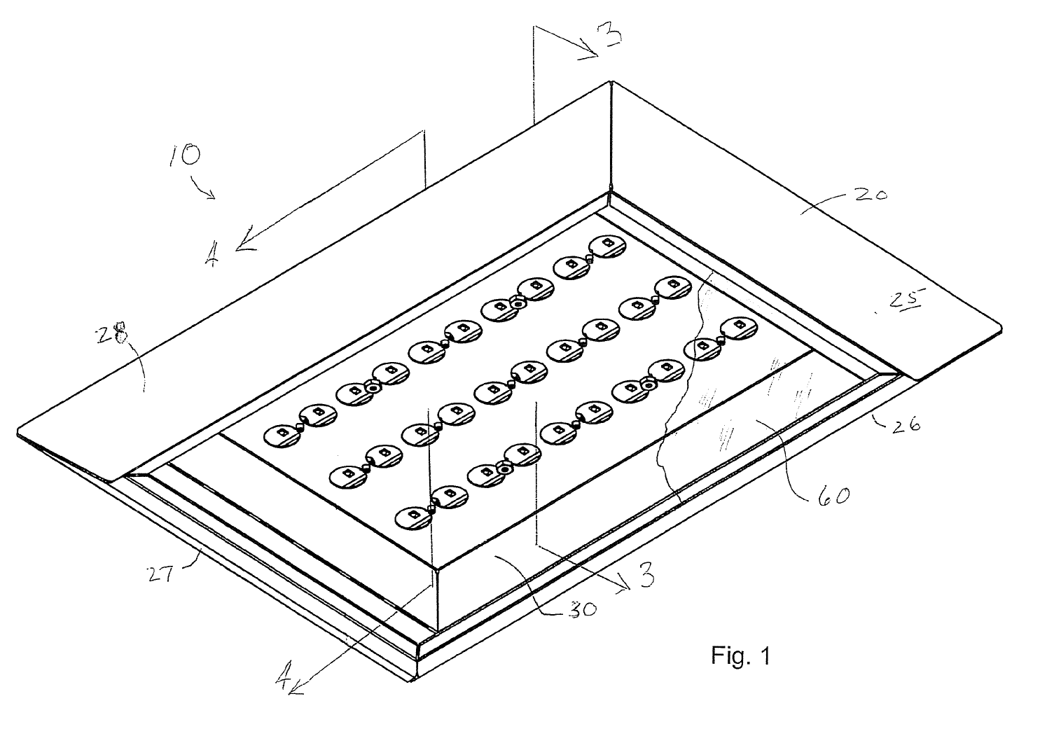

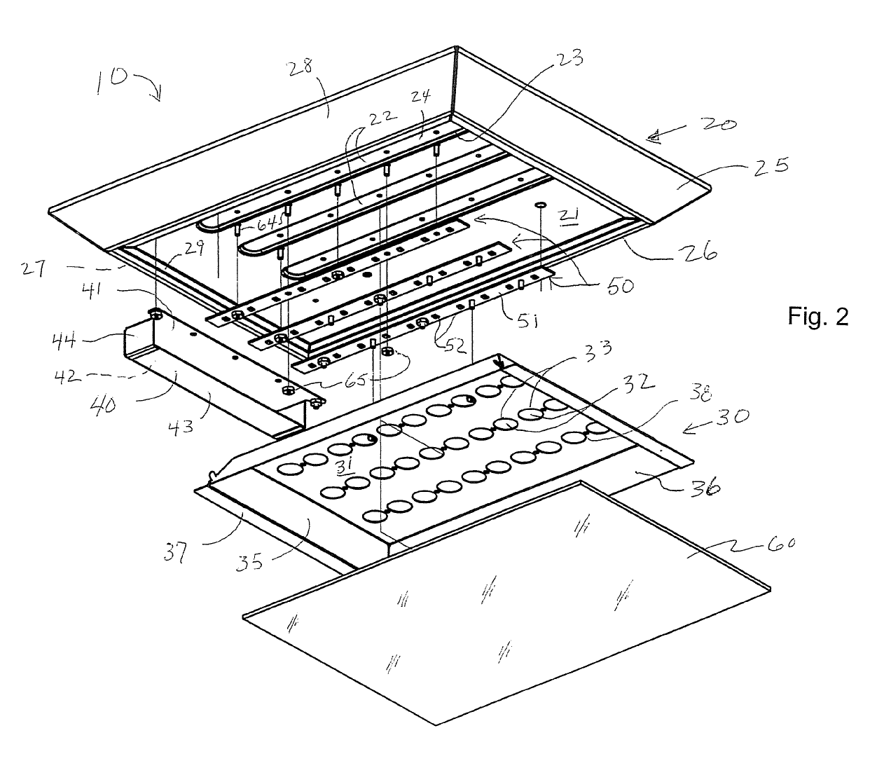

Referring now to the drawings, FIG. 1 shows a perspective view of a representative lighting apparatus 10 structure of the present invention, including a housing 20, cover plate 30 and light transmitting panel 60, shown partially sectioned. FIG. 2 shows an exploded view of the lighting apparatus 10. Apparatus 10 generally comprises the housing 20, cover plate 30, power supply (not shown) and control module frame assembly 40, one or more assemblies of light sources 50, the light transmitting transparent or translucent panel or lens 60 (flat or contoured in shape). Mounting brackets and other attachment elements (not shown in FIGS. 1 and 2) mount the assembled apparatus 10 on a supporting surface. Housing 20 as shown in FIGS. 1 and FIG. 2 comprises a rectangular base 21, side walls 25, 26, 27 and 28 attached to or are integral with base 21 and one or more recesses 22 of selected shape defined in the surface of base 21. It should be noted that the overall substantially rectangular shape of apparatus 10 of the drawing figures herein is representative of only one embodiment and various shapes are contemplated as within the scope of these teachings and the appended claims. Other housing shapes can be made within the scope of the present invention, including round, rectangular, oval and other irregular shapes. Further, as will be discussed more fully hereinafter, recesses 22 are configured to receive one or more light source assemblies corresponding in shape and number to the shape and number of recesses 22. Recesses 22 may therefore have any selected shape and size, or respective different shapes, sizes and arrangements in base 21 to receive the light source assemblies in corresponding shapes and numbers to accommodate a selected lighting arrangement. The elongate shape of recesses 22 and side-to-side juxtaposition of recesses 22 shown in FIG. 2 are only representative of the many arrangements within the scope of these teachings and as would occur to the skilled artisan practicing the invention guided by these teachings.

In the depicted embodiment, the light source assemblies 50 are comprised of LEDs for the source of light. The present invention can, however, employ any type of light source known to date or hereinafter created. The remainder of the specification will identify the light sources and light source assemblies 50 as constituting or employing LEDs, but is not intended to limit the scope of this disclosure or invention to use with LEDs, which may be substituted with any light source, as will be evident to persons of the ordinary skill in the art.

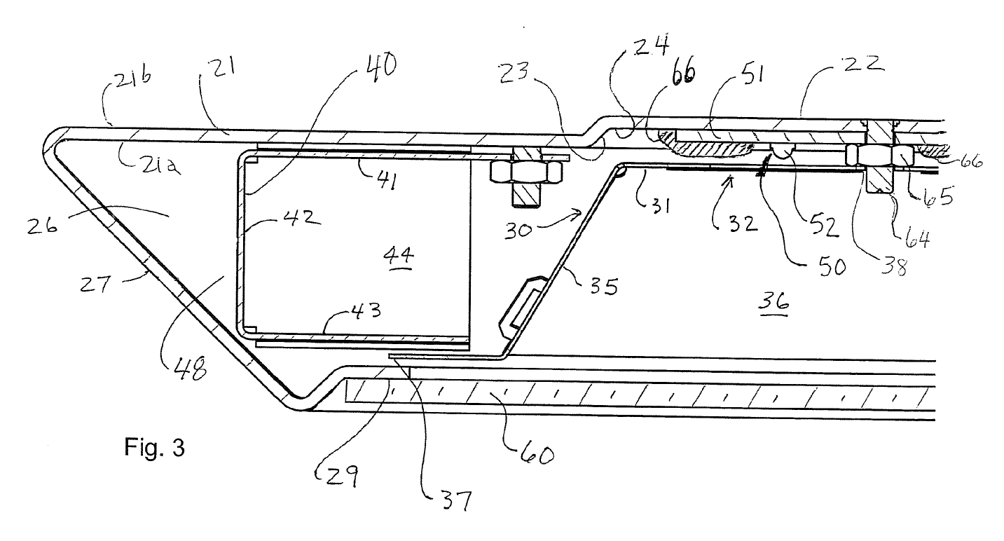

Reference is now made specifically to FIG. 3 that shows a sectional view of the lighting apparatus of FIG. 1 taken through line 3-3 thereof. Base 21 of housing 20 has a light source attachment surface 21a and an opposite back surface 21b that typically serves as the mounting surface of the lighting apparatus 10 to a wall, ceiling, building, or other structure.

Each recess 22 may be formed into the planar material of the planar base 21, such as by stamping or forming or molded when molding base 21. As shown in FIG. 3, a floor 24 of each recess 22 lies in a plane offset from the planar base 21, typically in a direction opposite the light source attachment surface 21a. The recesses 22 are shown as substantially linear, with rounded ends, though, as suggested above, other recess configurations and end shapes or different shapes can be used, as needed, such as round, square, oval, and other irregular shapes, to define a desired lighting arrangement.

Each recess 22 has a wall 23 that defines the perimeter of the recess 22. Typically, the wall 23 is continuous around the perimeter of the floor 24, though in some embodiments, there can be a break or discontinuity in the wall to accommodate placement of electrical leads, wiring or the like. The height of the wall 23 typically defines the depth of the recess 22, for purposes of positioning and securing a light source assembly therein, as discussed hereinafter.

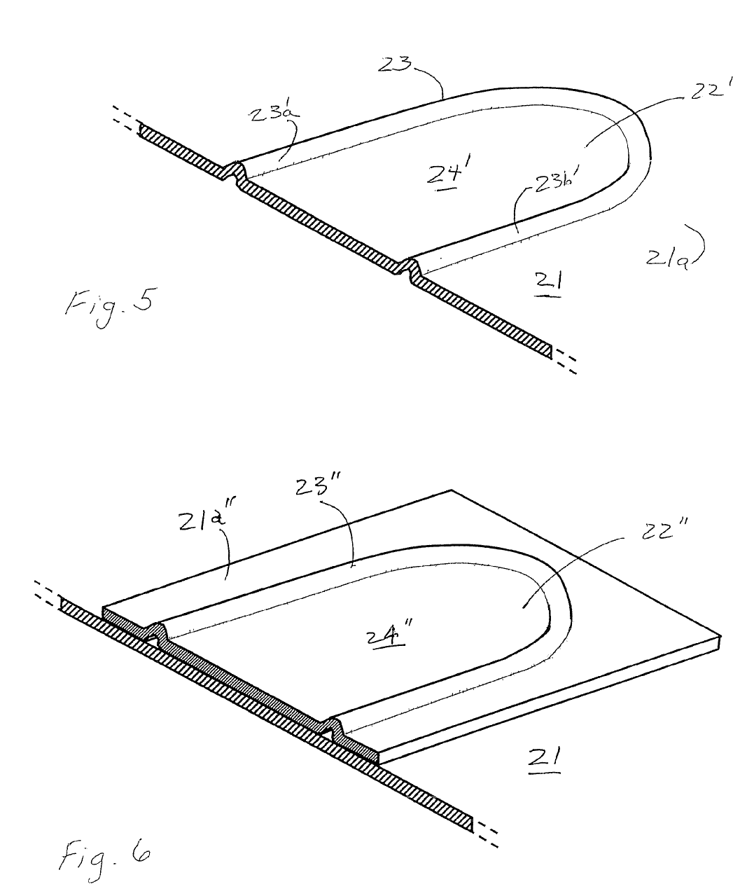

The illustrated floor 24 shown in FIGS. 2 and 3 lies in a plane that is offset from the planar base 21. In an alternative embodiment, shown in FIG. 5, the floor 24′ of recess 22′ can lie in the same plane as planar base 21, wherein the wall 23′ has sides 23a′ and 23b′ that extend outward from both the floor 24′ and the planar base 21, respectively. It can be understood that the floor 24′ can also lie in a plane offset from the planar base 21 in a direction toward the light source assembly, in which case the outer side 23b′ of wall 23′ would extend outwardly from the planar base 21 a distance greater than that of the inner wall 23a′ from the floor 24′.

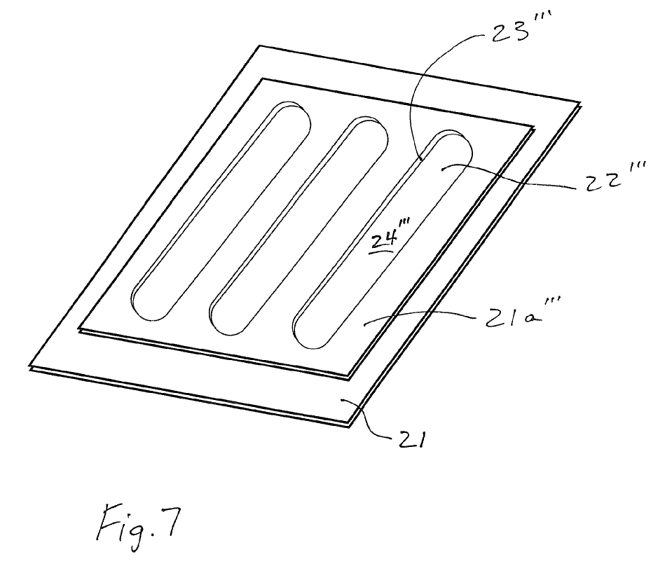

In another embodiment shown in FIG. 6, the wall 23″ of the recess 22″ can be a separate element 21a that is affixed to the planar base 21, to define the floor 24″ there within. As illustrated, the separate element can also comprise a module recess element, consisting of the floor and the wall in the form of an elongated trough, which is affixed to the planar base 21. Though these embodiments may require a separate forming step and attaching step to the planar base, both can provide the aspect of the disclosure of forming a recess within which the light source assembly can be disposed and secured.

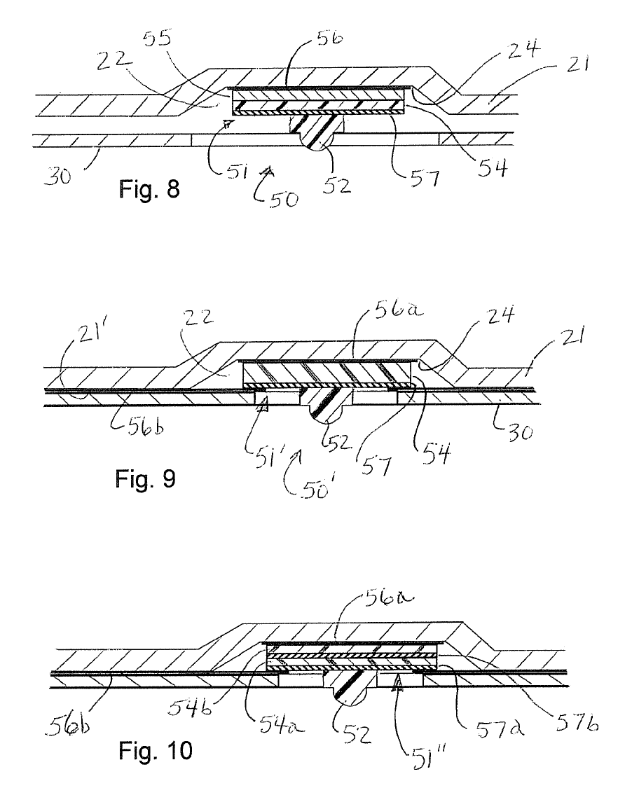

In yet another embodiment shown in FIG. 7, at least one planar sheet 21a′″ is disposed over and affixed by a fastener to the planar base 21, the planar sheet 21a′″ having at least one opening formed there through that defines the recess 22′″. The edge of the opening defines the wall 23′″ of the recess 22′″. The thickness of the planar sheet 21′″ defines the offset spacing of the floor 24′″ and the depth of the recess 22′″.

The housing 20 of lighting apparatus 10 can further comprise framed sidewalls, illustrated as perimeter sidewalls 25, 26, 27 and 28, attached to or integral with the periphery of the planar base 21 of the housing, and typically integral with the planar base. With reference specifically to FIG. 3, the framed sidewalls are configured to extend inwardly from an outer edge of the planar base 21 to form a cavity 48 within which the power supply and control module frame 40 can be disposed. In the illustrated embodiment, the sidewalls are straight and angled inwardly to form a cavity 48 having a triangular-shaped cross section. Other sidewall configurations can form rectilinear, oval-shaped, or other shaped cavities in cross-section, the illustrated shape not considered limiting of the disclosure. The sidewalls can be joined at their adjacent edges to form a substantially continuous peripheral cavity 48 around planar base 21 of the apparatus 10 structure.

An inwardly directed marginal flange 29 can be provided at the distal edges of the joined framed sidewalls 25, 26, 27 and 28 for supporting lens 60 using any suitable attaching means. It is noted that panel 60 may be attached to and supported by either the upper surface 21a or the lower surface 21b (as FIG. 3 is viewed) of marginal flange 29, in covering the opening of housing 20.

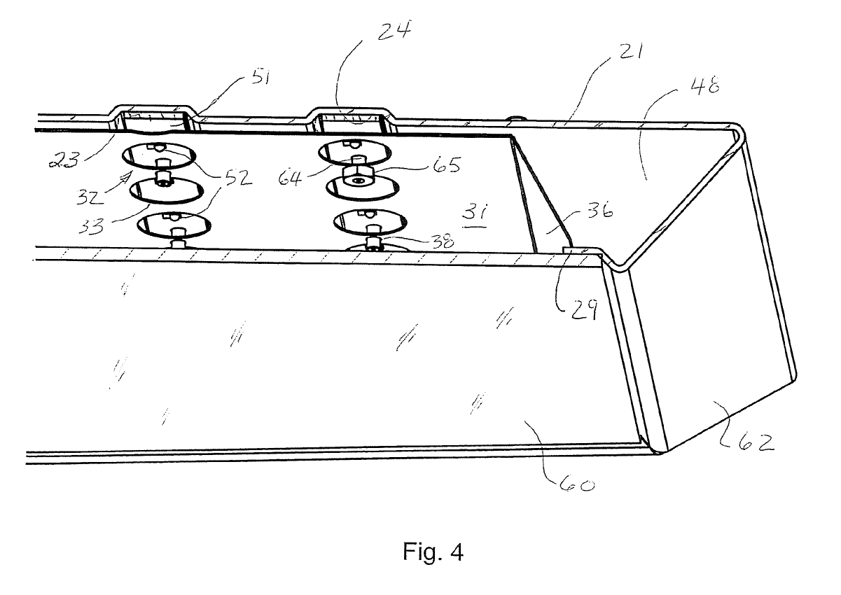

Referring now to FIGS. 2, 3 and 4, a representative structure and configuration for an LED light source assembly 50 can include a substrate 51 such as a light board, and typically a PCB, on which is mounted one or a plurality of LEDs 52, in any desired array. The circuitry for controlling and powering the LEDs can also be mounted or created on the PCB, or located remotely. The LEDs can be of any kind, color (i.e. emitting any color or white light or mixture of colors and white light as the intended lighting arrangement requires) and luminance capacity or intensity, preferably in the visible spectrum. Color selection can be made by one practicing the disclosure as the intended lighting arrangement requires. The LEDs contemplated within the teachings hereof can comprise any semiconductor configuration or material or combination. The LEDs can have a refractive optic built-in with the LED or placed over the LED, or no refractive optic; and can alternatively, or also, have a surrounding reflector that re-directs low-angle and mid-angle LED light outwardly. In one suitable embodiment, the LEDs 52 are white LEDs each comprising a gallium nitride (GaN)-based light emitting semiconductor device coupled to a coating containing one or more phosphors. The GaN-based semiconductor device emits light in the blue and/or ultraviolet range, and excites the phosphor coating to produce longer wavelength light. The combined light output approximates a white output. For example, a GaN-based semiconductor device generating blue light can be combined with a yellow phosphor to produce white light. Alternatively, a GaN-based semiconductor device generating ultraviolet light can be combined with red, green, and blue phosphors in a ratio and arrangement that produces white light. In yet another suitable embodiment, colored LEDs are used, such are phosphide-based semiconductor devices emitting red or green light, in which case the light source assembly 50 produces light of the corresponding color. In still yet another suitable embodiment, the light source assembly 50 includes red, green, and blue LEDs distributed on the PCB in a selected pattern to produce light of a selected color using a red-green-blue (RGB) color composition arrangement. In this latter exemplary embodiment, the LED light board can be configured to emit a selectable color by selective operation of the red, green, and blue LEDs at selected optical intensities.

The lighting apparatus 10 typically receives an external power supply having an off-line voltage of 110-277 V, depending upon the local power system. In one embodiment, an external low voltage power system can be provided that converts the off-line voltage of 110-277 V AC from the local power system to the 24V constant current (mAmp range) required for the LED power and control components of the light source assembly 50. In another embodiment, the LED lighting apparatus 10 is configured for installation of an integrated LED power and control module, which converts off-line power directly to the low voltage constant current power required by the LEDs. The drivers and controllers of LED boards are routinely powered with 24V constant current, which can be mounted within a power supply and control module frame 40 that is disposed within the housing 20 (FIG. 3).

FIG. 3 is a cross sectional view through the lighting apparatus 10 configured with LED light sources, and an LED cover plate 30 comprising a base 31 having a plurality of openings 32 defined by opening edges 33 (see also FIG. 2). The openings 32 are arranged in an array so as to register with the LEDs 52 on the light source assemblies 50 to allow light transmission there through. The cover plate 30 can be made from a reflective material or have a reflective coating, or other decorative pattern, which also serves to disguise the electronic circuitry associated with and attached to the outward-facing surface of the substrate 51 of the light source assembly 50. In the illustrated embodiment, the openings 32 are circular, matching the typical circular shape of an LED 52. Other opening shapes and array of shapes can be used, and may be configured in size and shape to register with more than one LED 52 as the intended lighting arrangement requires.

The cover plate 30 is typically placed with the base 31 up through the opening in the housing defined by flange 29. The cover plate 30 typically has extending from its periphery outwardly-flared peripheral walls defined by opposed pairs of sides 35 and 36, with an outwardly-extending distal edge 37 along the periphery of the sides 35 and 36. The distal edge 37 of the skirt formed of sides 35 and 36 can be biased or manipulated inwardly (toward a centerline of lighting apparatus 10, not shown, passing normal to the base 21), so that when the cover plate 30 is disposed within the housing 20, the outwardly-extending distal edges 37 rest on the upper surface (as FIG. 3 is viewed) of flange 29, thereby positioning the cover plate 30 in place over LEDs 52 within housing 20. The cover plate can also be positioned by aligning bolts 64 extending from the planar base 21 through holes 38 in the cover plate base. The cover plate can then be secured in position by nuts 65 threaded to the bolts 64. The exposed surfaces of sides 35 and 36 and base 31 can have a surface finish whereby cover plate 30 can serve as a reflector providing an additional light reflective surface on the lighting apparatus 10.

In another alternative embodiment, control for dimming the light output can be provided, either external to the structure, or internally built into the lighting apparatus 10 with control wiring passing externally to the structure.

The housing 20 may be made of aluminum or other metal by any of the well-known methods such as stamping, cold forming, die casting, permanent mold casting, machining or sand casting for forming aluminum commercially. Other parts, such as the cover plate, may also be made of aluminum or other metal. The housing and other parts can also be made of other metals such as bronze, brass, or others. The parts can also be made of engineering plastic materials, such as by injection molding.

A typical method of forming the aluminum housing 20 employs a brake press that secures the base portion in a plane, and folds the sides 25-28 to the desired angle relative to the base 21. The folded sides 25-28 are then confined in position while welding together the ends of the sidewalls where the sides 25-28 abut, which maintains the planar shape of the base. The light source assembly 50, cover plate 30, power frame and other components can be assembled to the housing 20 using a variety of fastening elements or fixing elements, including screws, bolts, rivets, welds, ties, latches, adhesives, and other fixing elements. In FIG. 2 are shown a plurality of threaded bolts 64 that are threaded or secured into tapped holes in the underside of the housing, which extend through holes formed in the cover plate and power frame, and optionally in the light source assembly board 50, and are capped with threaded nuts 65 to secure the elements to the housing 20.

The present disclosure also provides a method for securing each light source assembly 50 into a recess 22 of the housing 20 using a fastening element or fixing elements such as a potting material 66 (see FIG. 3). In one embodiment, the potting material 66 is as an epoxy or silicone-based material, that covers at least a portion, and more typically the entire surface, of the at least one light source assembly 50, and at the same time, fills at least a portion of, and more typically all of, the recess 22. Such potting materials have a low viscosity, a low density and are thermally conductive. Typical, non-limiting examples of potting epoxy resins can include Circalok™ 6715 and 6703 A/B, available from Lord Corporation, Cary N.C.

In a first step of the preferred method, the light source assembly 50 affixed thereto, is registered within the recess 22, typically being placed in heat-transfer contact to the floor 24 of the recess 22. Optionally, a small amount of epoxy resin, prior to setting, can be applied to the floor 24 of the recess to act as an adhesive to attach the light source assembly 50 to the housing 20. The epoxy resin then is poured over the light source assembly 50 and into and around the void of the recess 22. The epoxy resin can completely bury or encase the light source assembly 50. The epoxy resin can then be cured, by means well known in the art, including the passing of time, the application of heat, UV light or other radiation, or other means as applicable to the selected epoxy.

The potting epoxy can secure or assist in securing the light source assembly 50 within the recess 22, and, when using LEDs, isolates the LEDs and circuitry from water, dust, dirt and other elements of the environment. The recesses also assist in the assembly of the lighting assemblies, particularly when manufacturing the same by hand, by defining the location of the light source assembly exactly.

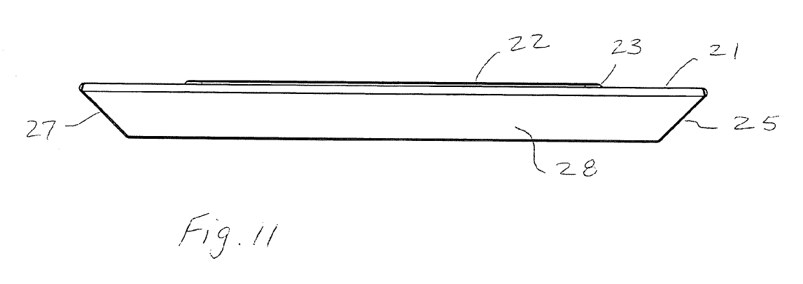

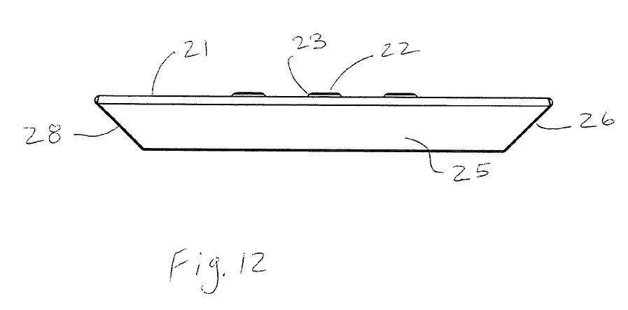

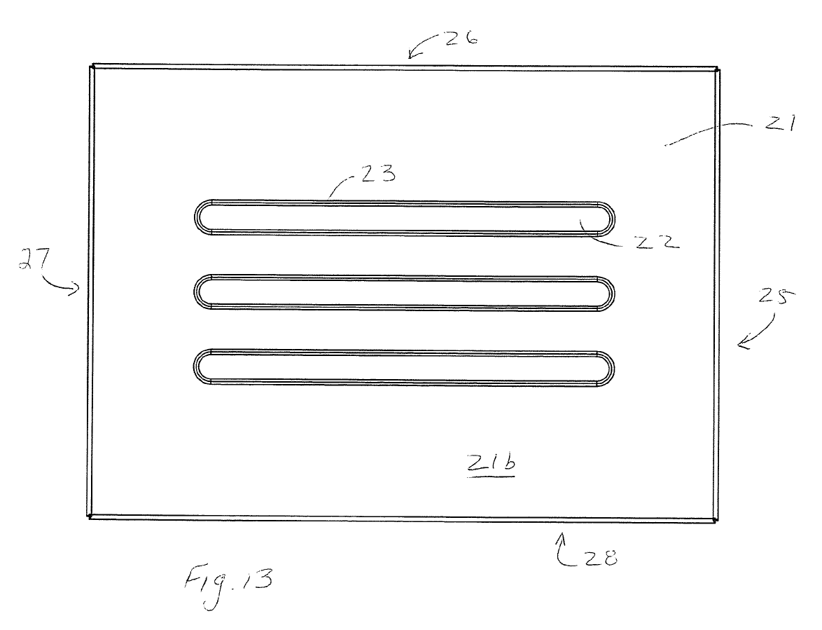

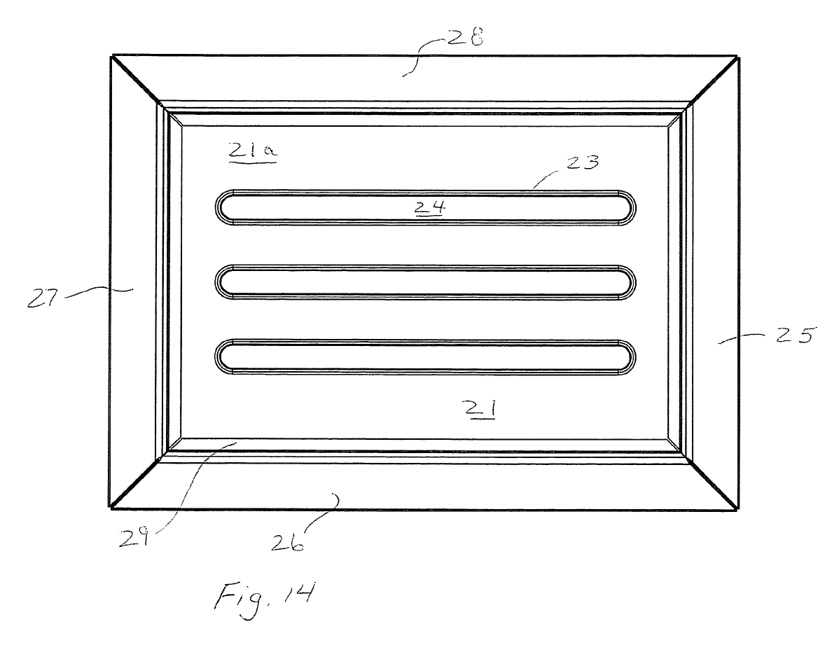

FIGS. 5-11 show various views of the ornamental shape of the housing. In the illustrated design, the broken lines show environment, and form no part of the claimed design.

While the disclosure has been described by reference to the details of various embodiments, it is understood that the disclosure is intended in an illustrative rather than in a limiting sense, as it is contemplated that modifications will readily occur to those skilled in the art, within the spirit of the invention and the scope of the appended claims.

1. A lighting apparatus comprising:
a housing having a substantially planar base, the base including at least one recess of selected shape, each recess having a floor and defined in the shape by a peripheral wall joining the floor to the planar base;
at least one light source assembly, each assembly including a one or more light sources supported on a substrate, the substrate corresponding in shape substantially to the shape of the recess and configured to register with the floor of the recess, the at least one light source assembly disposed within the recess; and
a fixing element that secures the at least one light source assembly within the recess.

2. The lighting apparatus according to claim 1 wherein the housing comprises aluminum.

3. The lighting apparatus according to claim 1 wherein the at least one recess is substantially elongate in shape and the substrate is correspondingly elongate in shape.

4. The lighting apparatus according to claim 3 wherein the planar base has a plurality of the elongate recesses and an LED assembly disposed within each of the plurality of recesses.

5. The lighting apparatus according to claim 4 wherein the plurality of elongate recesses are juxtaposed.

6. The lighting apparatus according to claim 1 wherein the fixing element comprises a potting epoxy that covers at least a portion of the light source assembly and fills at least a portion of the recess.

7. The lighting apparatus according to claim 1 wherein each floor is offset from the planar base.

8. The lighting apparatus according to claim 1 wherein the one or more light sources comprises a light emitting diode.

9. A lighting apparatus comprising
a housing having a substantially planar base, the base including at least one recess of selected shape, each the recess having a floor and defined in the shape by a peripheral wall joining the floor to the planar base, and a peripheral wall attached to or integral with the planar base, having on the distal edge thereof an inwardly directed marginal flange that defines an opening registering with the planar base;
at least one light source assembly, each light source assembly including at least one light source supported on a substrate, the substrate corresponding in shape substantially to the shape of a the recess and configured to register with the floor of a the recess, the at least one light source assembly disposed within the recess;
a fixing element for securing the at least one light source assembly within a the recess;
a cover plate disposed within the opening of the housing, the cover plate comprising a substantially planar bottom member and peripheral side walls attached to or integral with the planar bottom, the planar bottom member further including means defining a plurality of openings, each opening in registration with at least of the at least one light sources; and
an panel sized to cover the opening and configured to be supported on the marginal flange.

10. The lighting apparatus according to claim 9 further comprising a power converter for powering the at least one light source, the power converter being disposed within the peripheral wall.

11. The lighting apparatus according to claim 9 wherein the peripheral wall has an inwardly directed marginal flange forming a cavity.

12. The lighting apparatus according to claim 9 wherein the housing comprises aluminum.

13. The lighting apparatus according to claim 9 wherein the at least one recess is substantially elongate in shape, and the substrate is correspondingly elongate in shape.

14. The lighting apparatus according to claim 13 wherein the planar base has a plurality of the elongate recesses and light source assembly disposed within each of the plurality of recesses.

15. The lighting apparatus according to claim 14 wherein the plurality of elongate recesses are juxtaposed.

16. The lighting apparatus according to claim 9 wherein the fixing element comprises a potting epoxy that covers at least a portion of the light source assembly and fills at least a portion of the recess.

17. The lighting apparatus according to claim 9 wherein each floor is offset from the planar base.

18. The lighting apparatus according to claim 9 wherein the at least one light source comprises a light emitting diode.

19. The lighting apparatus according to claim 9 wherein the panel is transparent.

20. The lighting apparatus according to claim 9 wherein the panel is translucent.

21. A housing for retaining a plurality of lighting sources, including a substantially planar base including at least one recess of selected shape, each recess having a floor and defined in the shape by a peripheral wall joining the floor to the planar base.

22. The lighting apparatus according to claim 21 wherein the housing comprise aluminum.

23. The lighting apparatus according to claim 21 wherein each floor is offset from the planar base.

24. The lighting apparatus according to claim 21 wherein the at least one recess is substantially elongate in shape, and the substrate is correspondingly elongate in shape.

25. The lighting apparatus according to claim 24 wherein the planar base has a plurality of the elongate recesses, and a light emitting diode assembly disposed within each of the plurality of recesses.

26. The lighting apparatus according to claim 21 wherein the plurality of lighting sources comprise light emitting diodes.
